(19) United States
(12) Patent Application Publication
(10) Pub. No.: US 2026/0339148 A1
(43) Pub. Date: Oct. 29, 2026

(54) DISPLAY APPARATUS AND METHOD FOR MANUFACTURING OPTICAL MEMBER FOR DISPLAY APPARATUS

(71) Applicant: SAMSUNG ELECTRONICS CO., LTD., Suwon-si (KR)

(72) Inventors: Seongsig JU, Suwon-si (KR); Byoungjin CHO, Suwon-si (KR); Chanji JEONG, Suwon-si (KR); Wonyeop JANG, Suwon-si (KR); Naewon JANG, Suwon-si (KR); Seunggi KIM, Suwon-si (KR)

(73) Assignee: SAMSUNG ELECTRONICS CO., LTD., Suwon-si (KR)

(21) Appl. No.: 19/720,337

(22) Filed: Jun. 25, 2026

Related U.S. Application Data
(63) Continuation of application No. PCT/KR2026/002440, filed on Feb. 10, 2026.

(30) Foreign Application Priority Data
Apr. 25, 2025 (KR) 10-2025-0054894

(51) Int. Cl. G02F 1/1335; G02F 1/13357

(52) U.S. Cl. CPC G02F 1/133607; G02F 1/133603

(57) ABSTRACT

A display apparatus and a method for manufacturing an optical member for a display apparatus are provided. The display apparatus includes a display panel; a light source configured to emit light toward the display panel; and an optical member disposed between the display panel and the light source. The optical member includes a diffuser plate comprising a plurality of light diffusers and configured to diffuse light emitted from the light source; a foam layer comprising a plurality of cells and configured to diffuse light transmitted through the diffuser plate; and an optical pattern layer comprising a plurality of optical patterns and configured to refract light, which is transmitted through the foam layer, toward the display panel. The foam layer is disposed between the diffuser plate and the optical pattern layer and coupled to each of the diffuser plate and the optical pattern layer.

### CROSS-REFERENCE TO RELATED APPLICATIONS

This application is a Continuation Application of International Application No. PCT/KR2026/002440 filed on Feb. 10, 2026, which claims priority to Korean Patent Application No. 10-2025-0054894, filed on Apr. 25, 2025, at the Korean Ministry of Intellectual Property, the disclosures of which are incorporated herein in their entireties by reference.

### BACKGROUND

### 1. Field

The present disclosure relates to a display apparatus and a method for manufacturing an optical member for a display apparatus.

### 2. Description of Related Art

Generally, a display apparatus is a kind of an output apparatus that converts obtained or stored electrical information into visual information and displays the visual information to a user, and the display apparatus is used in various fields, such as home or workplace.

The display apparatus includes a monitor apparatus connected to a personal computer or a server computer, a portable computer device, a navigation terminal device, a general television apparatus, an Internet Protocol television (IPTV), a portable terminal device, such as a smart phone, a tablet PC, a personal digital assistant (PDA) or a cellular phone, various display apparatuses used to reproduce images, such as advertisements or movies in an industrial field, or various kinds of audio/video systems.

The display apparatus may include a self-luminous display panel such as an organic light-emitting diode (OLED) or a non-self-luminous display panel such as a liquid crystal display (LCD).

A display apparatus including the non-luminous display panel may include a display panel, a backlight unit configured to supply light to the display panel, and an optical member provided to improve luminance or uniformity of luminance of light supplied from the backlight unit to the display panel.

### SUMMARY

The present disclosure is directed to providing a display apparatus including an optical member having a simplified structure, and a method for manufacturing the optical member for a display apparatus.

The present disclosure is directed to providing a display apparatus having a reduced thickness, and a method for manufacturing the optical member for a display apparatus.

The present disclosure is directed to providing a display apparatus in which manufacturing and assembly processes of an optical member are simplified, and a method for manufacturing the optical member for a display apparatus.

The present disclosure is directed to providing an improved display apparatus capable of automating a manufacturing process or an assembly process of an optical member, and a method for manufacturing the optical member for a display apparatus.

The present disclosure is directed to providing a display apparatus having an improved efficiency in storage and distribution of an optical member and a method for manufacturing the optical member for a display apparatus.

The present disclosure is directed to providing a display apparatus having improved luminance, uniformity of luminance, and shielding properties of a screen, and a method for manufacturing the optical member for a display apparatus.

Additional aspects of the disclosure will be set forth in part in the description which follows and, in part, will be obvious from the description, or may be learned by practice of the disclosure.

According to an embodiment of the present disclosure, a display apparatus may include: a display panel; a light source configured to emit light toward the display panel; and an optical member disposed between the display panel and the light source. The optical member may include: a diffuser plate including a plurality of light diffusers and configured to diffuse light emitted from the light source; a foam layer including a plurality of cells and configured to diffuse light transmitted through the diffuser plate; and an optical pattern layer including a plurality of optical patterns and configured to refract light, which is transmitted through the foam layer, toward the display panel. The foam layer may be disposed between the diffuser plate and the optical pattern layer and coupled to each of the diffuser plate and the optical pattern layer.

According to an embodiment of the present disclosure, a method for manufacturing an optical member for a display apparatus may include: discharging a foam layer resin to which a foaming agent is added; discharging a diffuser plate resin, to which a plurality of light diffusers is added, to one side of the foam layer resin; discharging an optical pattern resin to the other side of the foam layer resin; forming a foam layer by forming a plurality of cells using the foaming agent and curing the foam layer resin; forming a diffuser plate, disposed on one surface of the foam layer and including the plurality of light diffusers, by curing the diffuser plate resin; and forming an optical pattern layer, disposed on the other surface of the foam layer, by imprinting a plurality of optical patterns on the optical pattern resin and curing the optical pattern resin.

According to an embodiment of the present disclosure, a display apparatus may include: a light source; and an optical member configured to transmit and modulate light emitted from the light source. The optical member may include: a diffuser plate including a plurality of light diffusers; an optical pattern layer including a plurality of optical patterns; and a foam layer disposed between the diffuser plate and the optical pattern layer and including a plurality of cells. The diffuser plate is configured to diffuse light emitted from the light source. The foam layer may be configured to diffuse light transmitted through the diffuser plate. The optical pattern layer may be configured to collect light transmitted through the foam layer.

According to an embodiment of the present disclosure, an optical member may include: a diffuser plate; a foam layer; and an optical pattern layer. The diffuser plate may be configured to diffuse light transmitted there through. The diffuser plate may include a plurality of light diffusers. The foam layer may be configured to diffuse light transmitted through the diffuser plate. The foam layer may include a plurality of cells. The optical pattern layer may be configured to refract light transmitted through the foam layer. The optical pattern layer may include a plurality of optical patterns. The foam layer may be disposed between the diffuser plate and the optical pattern layer. The foam layer may be coupled to each of the diffuser plate and the optical pattern layer.

### BRIEF DESCRIPTION OF THE DRAWINGS

FIG. 1 is a perspective view of a display apparatus according to one embodiment of the present disclosure.

FIG. 2 is an exploded perspective view of the display apparatus according to one embodiment of the present disclosure.

FIG. 3 is a cross-sectional view of a display panel included in the display apparatus according to one embodiment of the present disclosure.

FIG. 4 is a perspective view illustrating a state in which a light source device, a reflective sheet, and an optical member included in the display apparatus according to one embodiment of the present disclosure are disassembled.

FIG. 5 is a view illustrating the light source device, the reflective sheet, and the optical member included in the display apparatus according to one embodiment of the present disclosure.

FIG. 6 is an enlarged view of an optical member included in the display apparatus according to one embodiment of the present disclosure.

FIG. 7 is an enlarged view of an optical member included in the display apparatus according to one embodiment of the present disclosure.

FIG. 8 is a perspective view of an optical member included in a display apparatus according to one embodiment of the present disclosure.

FIG. 9 is a perspective view of an optical member included in a display apparatus according to one embodiment of the present disclosure.

FIG. 10 is a view illustrating an apparatus for manufacturing the optical member included in the display apparatus according to one embodiment of the present disclosure.

FIG. 11 is an enlarged view of a portion of the apparatus for manufacturing the optical member included in the display apparatus according to one embodiment of the present disclosure.

FIG. 12 is an enlarged view of a roller of the apparatus for manufacturing the optical member included in the display apparatus according to one embodiment of the present disclosure.

FIG. 13 is a flowchart illustrating manufacturing operations of the optical member included in the display apparatus according to one embodiment of the present disclosure.

### DETAILED DESCRIPTION

Embodiments described in the disclosure and configurations shown in the drawings are merely examples of the embodiments of the disclosure, and may be modified in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, numbers, steps, operations, elements, components, or combinations thereof, but do not preclude the presence or addition of one or more of the features, numbers, steps, operations, elements, components, or combinations thereof.

It will be understood that, although the terms first, second, third, and the like may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

In the following detailed description, the terms of “up and down direction”, “lower side”, “front and rear direction”, and the like may be defined by the drawings, but the shape and the location of the component is not limited by the term.

Hereinafter exemplary embodiments of the present disclosure will be described in detail with reference to the accompanying drawings.

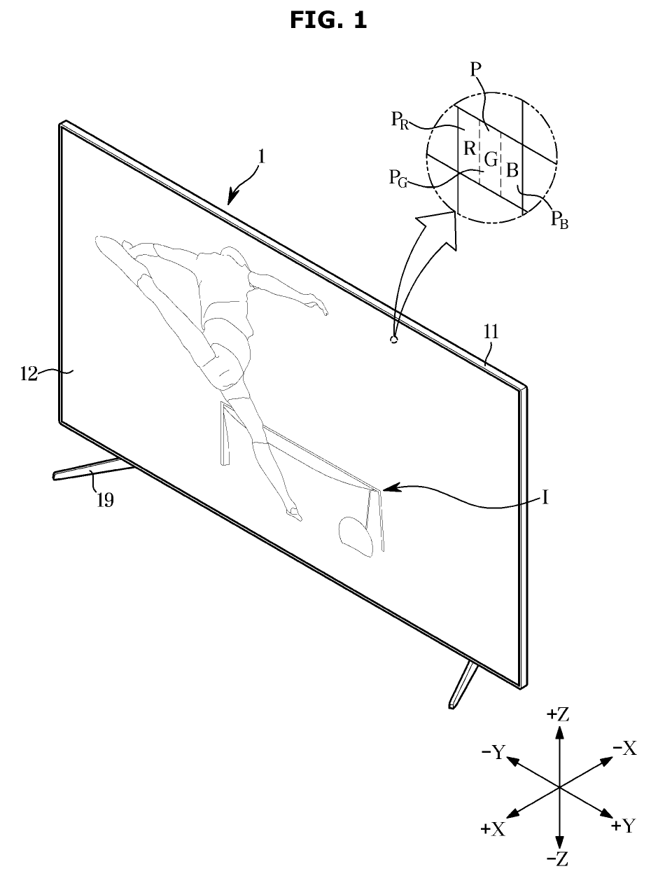

When describing various embodiments of the present disclosure with reference to FIGS. 1-13, the terms “front”, “rear”, “upper”, “lower”, “vertical direction”, “horizontal direction (left and right direction)”, and the like used in the following description are defined based on the drawings, and the shape and position of each component are not limited by these terms. For example, the term “front and rear direction” below may mean a direction parallel to the X direction based on the drawings, and “front” and “rear” may mean the +X direction and the -X direction, respectively, based on the drawings. For example, the term “vertical direction (up and down direction)” may mean a direction parallel to the Z direction based on the drawings, and “upper” and “lower” may mean the +Z direction and the -Z direction, respectively, based on the drawings. For example, the term “horizontal direction (left and right direction)” below may mean a direction parallel to the Y direction based on the drawings, and “left direction” and “right direction” may mean the -Y direction and the +Y direction, respectively, based on the drawings.

FIG. 1 is a perspective view of a display apparatus according to one embodiment of the present disclosure.

Referring to FIG. 1, a display apparatus 1 according to one embodiment of the present disclosure is a device that processes an image signal received from an outside source and visually displays the processed image.

For example, the display apparatus 1 according to one embodiment of the present disclosure may include various types of display apparatuses such as a television (TV), a monitor which is a type of computer output device, a portable multimedia device, a portable communication device, and the like. For example, the display apparatus 1 may be a large format display (LFD) installed outdoors, such as a roof of a building or a bus stop. The outdoors is not limited to the outside of a building, and thus the display apparatus 1 according to one embodiment may be installed in any places as long as the display apparatus is accessed by a large number of people, even indoors, such as subway stations, shopping malls, movie theaters, companies, and stores. The display apparatus 1 according to various embodiments of the present disclosure is not limited to the type described above as long as it is a device configured to visually display an image.

FIG. 1 illustrates that the display apparatus 1 is a flat-display apparatus in which a screen is flat but is not limited thereto. The display apparatus 1 according to various embodiments of the present disclosure may also include a curved display apparatus or a bendable or flexible display apparatus in which flat and curved states are variable. A configuration of the present disclosure described below may be applied to display apparatuses of various shapes regardless of a screen size or ratio of a display apparatus.

According to various embodiments, the display apparatus 1 may be installed in a standing manner on an indoor or outdoor floor or on furniture. For example, the display apparatus 1 may be installed in a standing manner on an indoor or outdoor floor or on furniture by including a support leg 19 provided to support a lower portion of a case of the display apparatus 1. According to various embodiments, the display apparatus 1 may be installed on a wall or inside a wall of a building or other structure. For example, the display apparatus 1 may be installed on a wall by a wall mount device.

The display apparatus 1 may receive content data including video data and audio data from various content sources and output video and audio corresponding to the video data and the audio data. For example, the display apparatus 1 may receive content data through a broadcast reception antenna or cable, receive content data from a content playback device, or receive content data from a content providing server of a content provider.

The display apparatus 1 may display an image corresponding to video data and output a sound corresponding to audio data. For example, the display apparatus 1 may restore a plurality of image frames included in the video data and continuously display the plurality of image frames. In addition, the display apparatus 1 may restore an audio signal included in the audio data and continuously output a sound based on the audio signal.

As illustrated in FIG. 1, the display apparatus 1 may include a main body 11, and a screen 12 provided to display an image I.

The main body 11 may form an appearance of the display apparatus 1. A component configured to allow the display apparatus 1 to display the image I and to perform various functions may be provided in the main body 11.

The display apparatus 1 may be configured to display the image I. Particularly, the screen 12 may be formed on a front surface of the main body 11, and the display apparatus 1 may display the image I on the screen 12. For example, the screen 12 may display a still image or a moving image. Further, the screen 12 may display a two-dimensional plane image or a three-dimensional image using binocular parallax of the user.

A plurality of pixels P may be formed on the screen 12. The image I displayed on the screen 12 may be formed by a combination of the lights emitted from the plurality of pixels P. For example, the image I may be formed on the screen 12 by combining light emitted from the plurality of pixels P as a mosaic.

Each of the plurality of pixels P may emit light of various brightness and various colors. Each of the plurality of pixels P may include sub-pixels P_{R}, P_{G}, and P_{B}, respectively. The sub-pixels P_{R}, P_{G}, and P_{B} may include a red sub-pixel P_{R} emitting red light, a green sub-pixel P_{G} emitting green light, and a blue sub-pixel P_{B} emitting blue light. For example, the red light may represent a light beam having a wavelength of approximately 620nm (nanometers, one billionth of a meter) to 750nm, the green light may represent a light beam having a wavelength of approximately 495nm to 570nm, and the blue light may represent a light beam having a wavelength of approximately 450nm to 495nm.

By combining the red light of the red sub-pixel P_{R}, the green light of the green sub-pixel P_{G} and the blue light of the blue sub-pixel P_{B}, each of the plurality of pixels P may emit different brightness and different color of light.

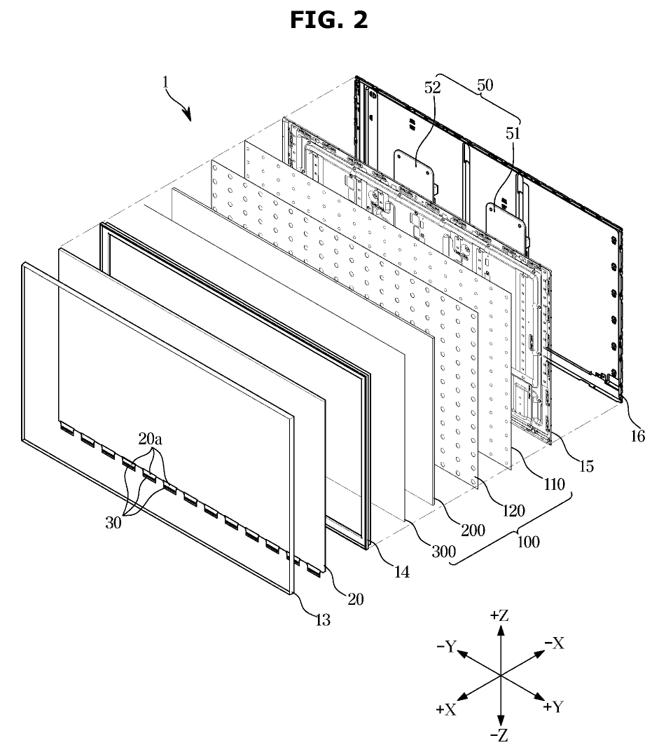

FIG. 2 is an exploded perspective view of the display apparatus according to one embodiment of the present disclosure.

Referring to FIG. 2, various components for generating the image I on the screen 12 may be provided inside the main body 11 of the display apparatus 1 according to one embodiment of the present disclosure.

For example, the display apparatus 1 may include a display panel 20. The display panel 20 may be arranged on the main body 11. The display panel 20 may be configured to display the image I. The screen 12 described in FIG. 1 may be formed on a front surface of the display panel 20.

For example, the display panel 20 may have an approximately rectangular shape. Particularly, the display panel 20 may have a shape in which lengths of the horizontal and vertical sides are different from each other. That is, the display panel 20 may have a long side and a short side. The display panel 20 may have a rectangular plate shape. However, the present disclosure is not limited thereto, and the display panel 20 may also have a square plate shape in which lengths of the long side and the short side are substantially equal.

In the display apparatus 1 according to one embodiment of the present disclosure, the display panel 20 may be configured as a panel of a self-luminous display type such as a liquid crystal display (LCD).

A cable 20a configured to transmit image data to the display panel 20, and a display driver integrated circuit (DDI) (hereinafter referred to as ‘driver IC’) 30 configured to process digital image data and output an analog image signal may be provided at one side of the display panel 20.

The cable 20a may electrically connect between a printed circuit board assembly (PBA) 50 and the driver IC 30. The cable 20a may electrically connect between the driver IC 30 and the display panel 20. The cable 20a may include a flexible flat cable or a film cable that is bendable.

The driver IC 30 may receive image data and power from the PBA 50 through the cable 20a. The driver IC 30 may transmit the image data and a driving current to the display panel 20 through the cable 20a.

The cable 20a and the driver IC 30 may be integrally formed with each other. For example, the cable 20a and the driver IC 30 may be implemented as a film cable, a chip on film (COF), or a tape carrier package (TCP). In other words, the driver IC 30 may be arranged on the cable 20a. However, the disclosure is not limited thereto, and the driver IC 30 may be arranged on the display panel 20.

A detailed description of the structure of the display panel 20 will be described later.

The display apparatus 1 may include a backlight unit 100 configured to emit light toward the display panel 20. The backlight unit 100 may be disposed in the main body 11. The backlight unit 100 may be disposed at a rear side of the display panel 20 and configured to emit light toward a front side in which the display panel 20 is located. Particularly, the backlight unit 100 may be configured as a surface light source. The display panel 20 may block or transmit light emitted from the backlight unit 100.

The backlight unit 100 may include a point light source configured to emit monochromatic light or white light, and may be configured to refract, reflect, and scatter light to convert light emitted from the point light source into uniform surface light. The backlight unit 100 may emit uniform surface light toward the front side by refracting, reflecting, and scattering light emitted from the point light source.

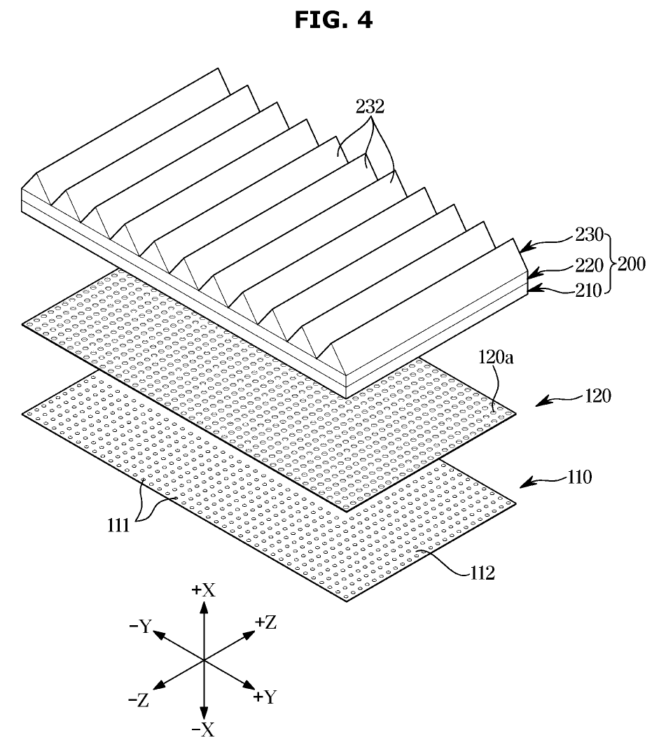

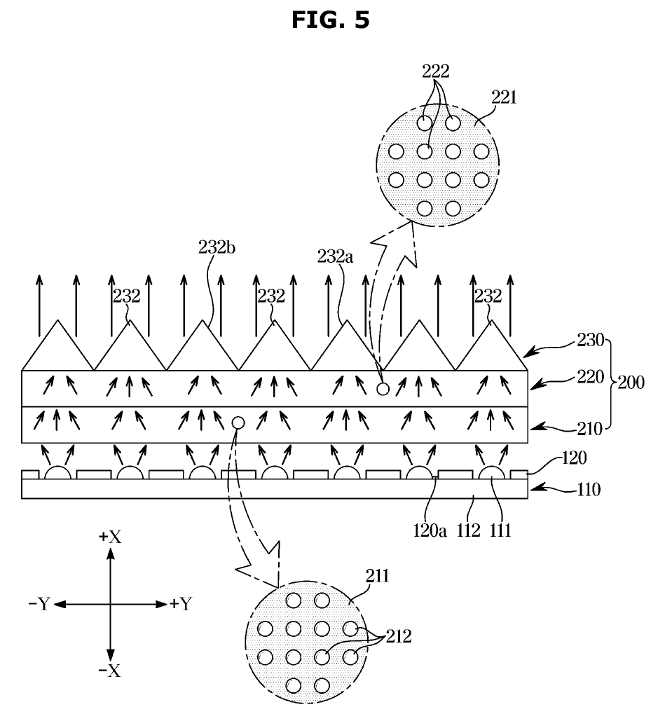

According to one embodiment, the backlight unit 100 may include a light source device 110. The light source device 110 may include a plurality of light sources 111 configured to emit light and a light source substrate 112 on which the plurality of light sources 111 is mounted (refer to FIGS. 4 and 5).

Each of the plurality of light sources 111 (refer to FIGS. 4 and 5) may be configured to emit monochromatic light or white light. Each of the plurality of light sources 111 may be configured as a point light source and may be configured to emit light in various directions. For example, the light sources 111 may include various light-emitting elements such as a Light Emitting Diode (LED).

Various electronic components including the plurality of light sources 111 may be mounted on the light source substrate 112 (refer to FIGS. 4 and 5). The light source substrate 112 may include a circuit pattern for transmitting a driving current and a signal to the light source 111. The light source substrate 112 may include a printed circuit board (PCB) on which a conductive circuit pattern is printed on at least one surface (for example, a front surface). For example, the plurality of light sources 111 may be mounted on a front surface of the light source substrate 112 and connected to the circuit pattern arranged on the front surface of the light source substrate 112.

The plurality of light sources 111 may be arranged spaced apart from each other on the light source substrate 112. For example, the plurality of light sources 111 may be arranged at approximately equal intervals from each other on the light source substrate 112. For example, the plurality of light sources 111 may be arranged in various ways, such as being arranged in an approximately matrix form on the light source substrate 112.

The configuration of the light source device 110 according to one embodiment of the present disclosure is not limited to that described above and illustrated in FIGS. 2, 4, and 5. In various embodiments, the light source device 110 may include various structures and arrangements configured to emit light.

According to one embodiment, the backlight unit 100 may include a reflective sheet 120 configured to reflect light. The reflective sheet 120 may reflect light to the front side or in a direction close to the front side.

For example, the reflective sheet 120 may be attached to the front surface of the light source substrate 112.

For example, the reflective sheet 120 may include a plurality of holes 120a (refer to FIGS. 4 and 5). The plurality of holes 120a may be arranged to correspond to the plurality of light sources 111 (refer to FIGS. 4 and 5). The plurality of light sources 111 may be arranged within the plurality of holes 120a. The plurality of light sources 111 may penetrate the plurality of holes 120a.

The light source device 110 (for example, the light source 111 of the light source device 110, refer to FIGS. 4 and 5) may emit light in various directions in front of the reflective sheet 120. A portion of the light emitted from the light source device 110 may travel toward an optical member 200 to be described later, but another portion of the light emitted from the light source device 110 may travel toward the reflective sheet 120. The reflective sheet 120 may reflect the light, which travels toward the reflective sheet 120, toward the optical member 200.

Alternatively, when light, which is emitted forward from the light source device 110, passes through various objects such as the optical member 200 or an optical sheet 300, a portion of the light may be reflected from a surface of the optical member 200 or the optical sheet 300. For this reason, the reflective sheet 120 may reflect light, which is reflected backward, to the front side again.

According to one embodiment, the backlight unit 100 may include the optical member 200. The optical member 200 may transmit light, which is emitted from the light source device 110, toward the display panel 20. The optical member 200 may transmit and modulate the light emitted from the light source device 110. The optical member 200 may be configured to improve luminance, uniformity of luminance, or shielding properties of light that is emitted from the light source device 110 and supplied to the display panel 20. For example, the optical member 200 may be configured to diffuse and collect light emitted from the light source device 110.

A detailed description of the structure and function of the optical member 200 will be described later.

According to one embodiment, the backlight unit 100 may further include the optical sheet 300. For example, the optical sheet 300 may be disposed in front of the optical member 200. The optical sheet 300 may be configured to further improve luminance, uniformity of luminance, and/or shielding properties of light transmitted through the optical member 200 and supplied to the display panel 20. The optical sheet 300 may be configured to improve color reproducibility of light supplied to the display panel 20. For example, the optical sheet 300 may be configured to refract and scatter light transmitted through the optical member 200. For example, the optical sheet 300 may include various types of sheets, such as a diffusion sheet, a prism sheet, a reflective polarizing sheet, and a quantum dot sheet.

The display apparatus 1 may include one or more PBAs 50. For example, the display apparatus 1 may include a control board 51 configured to control the operation of various components of the display apparatus 1, such as the backlight unit 100 and the display panel 20, and a power supply board 52 configured to supply power to various components of the display apparatus 1, such as the light source device 110 and the display panel 20. The control board 51 and the power supply board 52 may be electrically connected to each other. The control board 51 and the power supply board 52 may be disposed inside the main body 11.

For example, the control board 51 may include memory, a processor, and a circuit board on which the memory and the processor are mounted. For example, the power supply board 52 may include a capacitor, a coil, a resistor, and a processor, and a circuit board on which the capacitor, the coil, the resistor, and the processor are mounted.

The control board 51 may include a control circuit for controlling the operation of the plurality of light sources 111 and the display panel 20. The control circuit may process image data received from an external content source, transmit an image data signal to the display panel 20, and transmit a dimming data signal to the plurality of light sources 111.

The control board 51 may be connected to the light source substrate 112. The control board 51 may be connected to the light source substrate 112 via a cable or the like and may control the plurality of light sources 111. The control board 51 may be configured to supply a driving current to the plurality of light sources 111. The control board 51 may control on/off operation of each of the plurality of light sources 111.

FIG. 2 illustrates an example in which the control board 51 and the power supply board 61 are configured as separate circuit board assemblies but the control board 51 and the power supply board 61 may alternatively be configured as a single integrated board assembly.

According to one embodiment, the display apparatus 1 may include a case configured to support various components of the display apparatus 1. The various components of the display apparatus 1 may be accommodated inside the case. The case may form an outer shape of the display apparatus 1.

For example, the case may support the display panel 20. For example, the case may support the backlight unit 100 (for example, the light source device 110, the reflective sheet 120, the optical member 200, and the optical sheet 300). For example, the case may support the control board 51. For example, the case may support the power supply board 52.

According to one embodiment, the display apparatus 1 may include a front chassis 13. The front chassis 13 may include a front chassis 13 provided to support a front surface or a side surface of the display panel 20. For example, the front chassis 13 may be provided in a shape of an approximately square frame.

According to one embodiment, the display apparatus 1 may include a middle mold 14. The middle mold 14 may be disposed between the front chassis 13 and a rear chassis 15. For example, the middle mold 14 may be coupled to a rear side of the front chassis 13. For example, the middle mold 14 may support at least some components of the backlight unit 100.

According to one embodiment, the display apparatus 1 may include the rear chassis 15. The rear chassis 15 may be disposed at a rear side of the front chassis 13 and the middle mold 14. For example, the rear chassis 15 may be coupled to the rear side of the middle mold 14. For example, the rear chassis 15 may cover the rear side of the backlight unit 100, such as the light source device 110. For example, the rear chassis 15 may support various components of the display apparatus 1, such as the backlight unit 100, the control board 51, and the power supply board 52.

The rear chassis 15 may be formed to have an approximately flat plate shape but is not limited thereto. The rear chassis 15 may be formed of a material having high thermal conductivity to dissipate heat generated from the backlight unit 100 to the outside. For example, the rear chassis 15 may be formed of a metal material such as aluminum or Stainless Use Steel (SUS), or a plastic material such as Acrylonitrile Butadiene Styrene (ABS).

According to one embodiment, the display apparatus 1 may include a rear cover 16. The rear cover 16 may be disposed at a rear side of the rear chassis 15 and may cover the rear chassis 15 and various components (for example, the control board 51 and the power supply board 52) mounted at the rear side of the rear chassis 15. The rear cover 16 may form a rear exterior of the display apparatus 1. For example, the support leg 19 may be coupled to the rear cover 16.

However, unlike the above-described description, in various embodiments, the case of the display apparatus 1 may not include any of the components of the front chassis 13, the middle mold 14, the rear chassis 15, and the rear cover 16 described above.

The configuration of the display apparatus 1 described above with reference to FIG. 2 is merely an example for describing the display apparatus 1 according to one embodiment of the present disclosure, and the present disclosure is not limited thereto. In various embodiments of the present disclosure, the display apparatus may be provided to include various configurations for performing the function of providing an image on a screen.

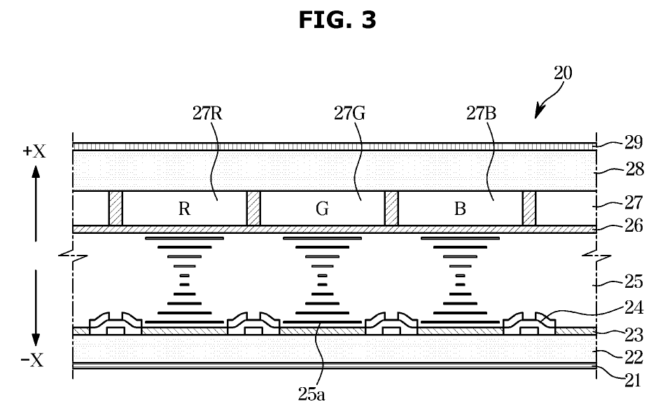

FIG. 3 is a cross-sectional view of a display panel included in the display apparatus according to one embodiment of the present disclosure.

Referring to FIG. 3, the display panel 20 included in the display apparatus 1 according to one embodiment of the present disclosure may be configured as a liquid crystal display (LCD) panel and may be configured to block or transmit light emitted from the backlight unit 100. By an operation in which the display panel 20 blocks or transmit light emitted from the backlight unit 100, the image I may be formed in front of the display panel 20.

The front surface of the display panel 20 may form the screen 12 of the display apparatus 1 described above. The plurality of pixels P may be provided on the display panel 20. The plurality of pixels P provided on the display panel 20 may independently block or transmit light of the backlight unit 100, and the light transmitted by the plurality of pixels P may form the image I displayed on the screen 12.

For example, as illustrated in FIG. 3, the display panel 20 may include a first polarizing film 21, a first transparent substrate 22, a pixel electrode 23, a thin film transistor 24, a liquid crystal layer 25, a common electrode 26, a color filter 27, a second transparent substrate 28, and a second polarizing film 29.

The first transparent substrate 22 and the second transparent substrate 28 may fixedly support the pixel electrode 23, the thin film transistor 24, the liquid crystal layer 25, the common electrode 26, and the color filter 27. The first and second transparent substrates 22 and 28 may be formed of tempered glass or transparent resin.

The first polarizing film 21 and the second polarizing film 29 may be provided on the outside of the first and second transparent substrates 22 and 28.

Each of the first polarizing film 21 and the second polarizing film 29 may transmit a specific light beam and block other light beams. For example, the first polarizing film 21 may transmit a light beam having a magnetic field vibrating in a first direction and block other light beams. In addition, the second polarizing film 29 may transmit a light beam having a magnetic field vibrating in a second direction and block other light beams. At this time, the first direction and the second direction may be perpendicular to each other. Accordingly, a polarization direction of the light transmitted through the first polarizing film 21 and a polarization direction of the light transmitted through the second polarizing film 29 may be perpendicular to each other. As a result, in general, light may not be transmitted through the first polarizing film 21 and the second polarizing film 29 at the same time.

The color filter 27 may be provided on an inner side of the second transparent substrate 28.

The color filter 27 may include a red filter 27R transmitting red light, a green filter 27G transmitting green light, and a blue filter 27B transmitting blue light. The red filter 27R, the green filter 27G, and the blue filter 27B may be disposed parallel to each other. A region, in which the color filter 27 is formed, may correspond to the pixel P described above. A region, in which the red filter 27R is formed, may correspond to the red sub-pixel P_{R}, a region, in which the green filter 27G is formed, may correspond to the green sub-pixel P_{G}, and a region, in which the blue filter 27B is formed, may correspond to the blue sub-pixel P_{B}.

The pixel electrode 23 may be provided on an inner side of the first transparent substrate 22, and the common electrode 26 may be provided on an inner side of the second transparent substrate 28.

The pixel electrode 23 and the common electrode 26 may be formed of a metal material through which electricity is conducted, and the pixel electrode 23 and the common electrode 26 may generate an electric field to change arrangement of liquid crystal molecules 25a forming the liquid crystal layer 25 to be described below.

The pixel electrode 23 and the common electrode 26 may be formed of a transparent material, and may transmit light incident from the outside. For example, the pixel electrode 23 and the common electrode 26 may include indium tin oxide (ITO), indium zinc oxide (IZO), silver nanowire (Ag nanowire), carbon nanotube (CNT), graphene, or poly (3,4-ethylenedioxythiophene) (PEDOT). The thin film transistor (TFT) 24 may be provided in an inner side of the first transparent substrate 22.

The TFT 24 may transmit or block a current flowing through the pixel electrode 23. For example, an electric field may be formed or removed between the pixel electrode 23 and the common electrode 26 in response to turning on (closing) or turning off (opening) the TFT 24.

The TFT 24 may be formed of poly-silicon, and may be formed by semiconductor processes, such as lithography, deposition, and ion implantation.

The liquid crystal layer 25 may be formed between the pixel electrode 23 and the common electrode 26. The liquid crystal layer 25 may be filled with the liquid crystal molecules 25a.

Liquid crystals represent an intermediate state between a solid (crystal) and a liquid. Most of the liquid crystal materials are organic compounds, and the molecular shape is in the shape of an elongated rod. The orientation of molecules is in an irregular state in one direction, but in a regular state in other directions. As a result, the liquid crystal has both the fluidity of the liquid and the optical anisotropy of the crystal (solid).

Liquid crystals also exhibit optical properties according to changes in an electric field. For example, in the liquid crystal, the orientation of molecules forming the liquid crystal may change according to a change in an electric field. In response to an electric field being generated in the liquid crystal layer 25, the liquid crystal molecules 25a of the liquid crystal layer 25 may be disposed along the direction of the electric field. In response to the electric field not being generated in the liquid crystal layer 25, the liquid crystal molecules 25a may be disposed irregularly or disposed along an alignment layer (not shown). As a result, the optical properties of the liquid crystal layer 25 may vary depending on the presence or absence of the electric field passing through the liquid crystal layer 25.

The structure of the display panel 20 described above with reference to FIG. 3 is merely an example of a structure of the display panel 20 of the display apparatus 1 according to one embodiment of the present disclosure, and the present disclosure is not limited thereto.

FIG. 4 is a perspective view illustrating a state in which a light source device, a reflective sheet, and an optical member included in the display apparatus according to one embodiment of the present disclosure are disassembled. FIG. 5 is a view illustrating the light source device, the reflective sheet, and the optical member included in the display apparatus according to one embodiment of the present disclosure.

Referring to FIGS. 4 and 5, the display apparatus 1 according to one embodiment of the present disclosure may include the optical member 200. The optical member 200 may be disposed between the light source device 110 and the display panel 20. The optical member 200 may be disposed between the light source device 110 and the display panel 20. The optical member 200 may be disposed between the reflective sheet 120 and the display panel 20. For example, the optical member 200 may be disposed in front of the light source device 110. For example, the optical member 200 may be disposed in front of the reflective sheet 120.

According to one embodiment, light emitted from the plurality of light sources 111 or light reflected by the reflective sheet 120 may be incident on the optical member 200. The optical member 200 may be configured to transmit the light, which is emitted from the plurality of light sources 111 or reflected by the reflective sheet 120, to the display panel 20. The optical member 200 may modulate the light emitted from the plurality of light sources 111 or light reflected by the reflective sheet 120. The modulated light may be emitted toward the display panel 20. The expression “the optical member 200 modulates light” may include cases where the optical member 200 modulates light in various ways, such as reflecting, refracting, or scattering light incident on the optical member 200. The optical member 200 may modulate the light in various ways, such as reflection, refraction, and scattering, so as to control and/or improve various optical characteristics, such as intensity, wavelength, traveling direction, dispersion, phase, and polarization direction, of the emitted light according to the purpose.

As described above, because the plurality of light sources 111 of the light source device 110 are arranged spaced apart from each other on the light source substrate 112, when the light emitted from the plurality of light sources 111 is incident directly onto the display panel 20, there is a possibility that the uniformity of luminance on the screen 12 may be reduced. In addition, among the components arranged inside the main body 11, various components may be arranged between the light source device 110 or the reflective sheet 120 and the display panel 20. Because a portion of the light may be interfered with or blocked by these components, there may be a possibility that a Mura phenomenon, in which a pattern or stain is visible on the screen 12, may occur.

According to one embodiment, the optical member 200 may improve the uniformity of luminance by diffusing light emitted from the plurality of light sources 111 and may improve the shielding property to prevent patterns or stains from being visible on the screen 12.

According to one embodiment, the optical member 200 may include a diffuser plate 210. The diffuser plate 210 may be disposed between the light source device 110 and the display panel 20. For example, the diffuser plate 210 may be disposed in front of the light source device 110. For example, the diffuser plate 210 may almost entirely cover the light source device 110 from the front side. For example, the diffuser plate 210 may be disposed in front of the reflective sheet 120. For example, the diffuser plate 210 may almost entirely cover the reflective sheet 120 from the front side.

The diffuser plate 210 may be configured to diffuse light emitted from the plurality of light sources 111. The diffuser plate 210 may diffuse light, which is emitted from the plurality of light sources 111, and emit the light toward the display panel 20. For example, the diffuser plate 210 may diffuse light, which is emitted from the plurality of light sources 111, and emit the light toward a foam layer 220 and an optical pattern layer 230 to be described later. For example, the diffuser plate 210 may diffuse light, which is emitted from the plurality of light sources 111, and emit the light forward.

According to one embodiment, the diffuser plate 210 may include a diffuser plate resin 211. The diffuser plate resin 211 may be configured to transmit light. For example, the diffuser plate resin 211 may include various transparent materials configured to transmit light. For example, the diffuser plate 210 may be formed as a molten diffuser plate resin 211 is cured.

According to various embodiments, the diffuser plate resin 211 may include various materials such as polystyrene (PS), polycarbonate (PC), polymethyl methacrylate (PMMA), and polyethylene terephthalate (PET).

The diffuser plate 210 may include a light diffuser 212. The light diffuser 212 may include fine particles added to the diffuser plate resin 211. For example, the light diffuser 212 may include fine beads that diffuse light.

The diffuser plate 210 may include a plurality of light diffusers 212 arranged inside the diffuser plate resin 211. Because there is a difference between a refractive index of the light diffuser 212 and a refractive index of the diffuser plate resin 211, at least a portion of the light transmitted through the diffuser plate resin 211 may be refracted or scattered by the plurality of light diffusers 212. As a result, the diffuser plate 210 may diffuse the incident light in various directions.

According to one embodiment, the refractive index of the plurality of light diffusers 212 may be greater than the refractive index of the diffuser plate resin 211.

With this structure, light emitted from the light source 111 may be evenly distributed while passing through the diffuser plate 210, and the uniformity of luminance and shielding properties of light supplied to the display panel 20 may be improved.

For example, the diffuser plate 210 may have a substantially flat plate shape. Front and rear surfaces of the diffuser plate 210 may be substantially flat.

For example, the diffuser plate 210 may be arranged parallel to the display panel 20. For example, the diffuser plate 210 may be arranged parallel to the light source device 110. For example, the diffuser plate 210 may be arranged parallel to the reflective sheet 120. For example, the diffuser plate 210 may be arranged approximately perpendicular to the front and rear direction X.

According to one embodiment, the optical member 200 may include the foam layer 220. The foam layer 220 may be disposed between the light source device 110 and the display panel 20. The foam layer 220 may be disposed between the diffuser plate 210 and the display panel 20. The foam layer 220 may be disposed between the diffuser plate 210 and the optical pattern layer 230 to be described later. For example, the foam layer 220 may be disposed in front of the diffuser plate 210. For example, the foam layer 220 may almost entirely cover the diffuser plate 210 from the front side.

The foam layer 220 may be configured to diffuse light that is emitted from the plurality of light sources 111 and transmitted through the diffuser plate 210. The foam layer 220 may diffuse light, which is transmitted through the diffuser plate 210, and emit the light toward the display panel 20. For example, the foam layer 220 may diffuse light, which is transmitted through the diffuser plate 210, and emit the light toward the optical pattern layer 230 to be described later. For example, the foam layer 220 may diffuse light, which is transmitted through the diffuser plate 210, and emit the light forward.

According to one embodiment, the foam layer 220 may include a foam layer resin 221. The foam layer resin 221 may be configured to transmit light. For example, the foam layer resin 221 may include various transparent materials configured to transmit light. For example, the foam layer 220 may be formed as a molten foam layer resin 221 is cured.

According to various embodiments, the foam layer resin 221 may include various materials such as polystyrene (PS), polycarbonate (PC), polymethyl methacrylate (PMMA), and polyethylene terephthalate (PET).

According to one embodiment, materials of the diffuser plate resin 211 and the foam layer resin 221 may be the same, but various embodiments are not limited thereto.

The foam layer 220 may include a plurality of cells 222. The plurality of cells 222 may be arranged inside the foam layer resin 221. For example, the plurality of cells 222 may be formed in a foaming process of a foaming agent added to the foam layer resin 221. For example, because there is a difference between a refractive index of the cell 222 and a refractive index of the foam layer resin 221, at least a portion of the light transmitted through the foam layer resin 221 may be refracted or scattered by the plurality of cells 222. As a result, the foam layer 220 may diffuse the incident light in various directions. An empty space may be formed inside each of the plurality of cells 222. The empty space may be formed by foaming. The empty space may be filled with air. Each of the plurality of cells 222 may be referred to as an 'air-filled cell'.

For example, the foaming agent may include a variety of physical foaming agents, such as gaseous carbon dioxide, or a variety of chemical foaming agents including organic or inorganic foaming agents.

With this structure, light, which is transmitted through the diffuser plate 210 and diffused, may be more evenly distributed while passing through the foam layer 220. The uniformity of luminance and shielding properties of light supplied to the display panel 20 may be improved.

For example, the foam layer 220 may have a substantially flat plate shape. Front and rear surfaces of the foam layer 220 may be substantially flat.

For example, the foam layer 220 may be arranged parallel to the display panel 20. For example, the foam layer 220 may be arranged parallel to the light source device 110. For example, the foam layer 220 may be arranged parallel to the reflective sheet 120. For example, the foam layer 220 may be arranged parallel to the diffuser plate 210. For example, the foam layer 220 may be arranged approximately perpendicular to the front and rear direction X.

As mentioned above, as the light emitted from the plurality of light sources 111 is diffused while passing through the diffuser plate 210 and the foam layer 220, the uniformity of luminance or shielding properties of the light supplied to the display panel 20 may be improved, but the luminance of the light may not be sufficiently high. According to one embodiment, the optical member 200 may refract and collect light, which is diffused while passing through the diffuser plate 210 and the foam layer 220, toward the display panel 20. Accordingly, the optical member 200 may improve the luminance of the light supplied to the display panel 20.

According to one embodiment, the optical member 200 may include the optical pattern layer 230. The optical pattern layer 230 may be disposed between the light source device 110 and the display panel 20. The optical pattern layer 230 may be disposed between the diffuser plate 210 and the display panel 20. The optical pattern layer 230 may be disposed between the foam layer 220 and the display panel 20. For example, the optical pattern layer 230 may be disposed in front of the foam layer 220. For example, the optical pattern layer 230 may almost entirely cover the foam layer 220 from the front side.

The optical pattern layer 230 may be configured to refract light transmitted through the foam layer 220. The optical pattern layer 230 may be configured to transmit and refract light transmitted through the foam layer 220. The optical pattern layer 230 may be configured to refract light, which is transmitted through the foam layer 220, toward the display panel 20. The optical pattern layer 230 may be configured to collect light transmitted through the foam layer 220. For example, the optical pattern layer 230 may be configured to refract light, which is transmitted through the foam layer 220, to the front side.

According to one embodiment, the optical pattern layer 230 may include a plurality of optical patterns 232. Each of the plurality of optical patterns 232 may be configured to refract light transmitted through the foam layer 220. Each of the plurality of optical patterns 232 may be configured to transmit and refract light transmitted through the foam layer 220. Each of the plurality of optical patterns 232 may be configured to refract light, which is transmitted through the foam layer 220, toward the display panel 20. Each of the plurality of optical patterns 232 may be configured to collect light transmitted through the foam layer 220. For example, each of the plurality of optical patterns 232 may be configured to refract light, which is transmitted through the foam layer 220, to the front side.

The plurality of optical patterns 232 may be arranged on one surface of the foam layer 220. For example, the plurality of optical patterns 232 may be arranged on a front surface of the foam layer 220 facing the display panel 20.

According to one embodiment, the plurality of optical patterns 232 may be arranged in one direction on one surface of the foam layer 220. For example, the plurality of optical patterns 232 may be arranged in a direction parallel to a long side direction of the screen 12. For example, the plurality of optical patterns 232 may be arranged in the horizontal direction Y. However, the arrangement direction of the plurality of optical patterns 232 is not limited thereto, and the plurality of optical patterns 232 may be arranged in various directions.

According to one embodiment, the plurality of optical patterns 232 may include a plurality of prisms. Each of the plurality of optical patterns 232 may have a prism shape. The plurality of prisms may be arranged along one surface of the foam layer 220. For example, the plurality of prisms may be arranged along the front surface of the foam layer 220. Each of the plurality of prisms may have a width that is reduced from the foam layer 220 toward the display panel 20. For example, each of the plurality of prisms may protrude forward from the front surface of the foam layer 220, and as a protrusion length increases, a width in the horizontal direction may be reduced.

For example, each of the plurality of optical patterns 232 may include a first inclined surface 232a and a second inclined surface 232b which are inclined with respect to the front and rear direction X. The first inclined surface 232a and the second inclined surface 232b included in the optical pattern 232 may extend in a direction in which a distance between the first inclined surface 232a and the second inclined surface 232b is reduced as the first inclined surface 232a and the second inclined surface 232b are away from the foam layer 220. That is, a distance between one end of the first inclined surface 232a adjacent to the foam layer 220 and one end of the second inclined surface 232b adjacent to the foam layer 220 may be greater than a distance between the other end of the first inclined surface 232a and the other end of the second inclined surface 232b.

However, the shape of the optical pattern 232 is not limited thereto, and in various embodiments, the optical pattern layer 230 may include optical patterns of various shapes capable of collecting light incident from the foam layer 220.

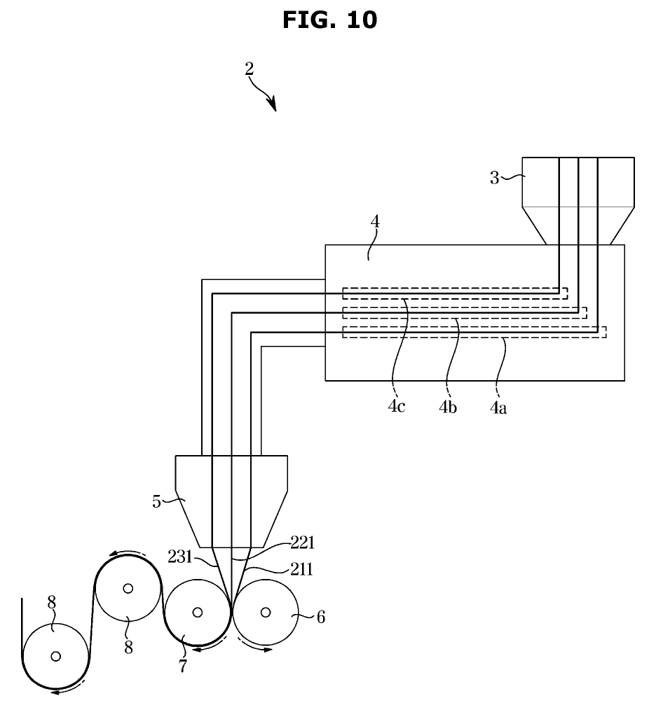

According to one embodiment, the optical pattern layer 230 may include an optical pattern resin 231 (refer to FIGS. 10, 11, and 12). The optical pattern layer 230 may be formed as a molten optical pattern resin 231 is cured.

The optical pattern resin 231 may include various resin materials that are transparent to light and have a high refractive index. According to one embodiment, a refractive index of the optical pattern layer 230 may be greater than a refractive index of the foam layer 220 and a refractive index of the diffuser plate 210. According to one embodiment, a refractive index of the optical pattern resin 231 may be greater than a refractive index of the foam layer resin 221 and a refractive index of the diffuser plate resin 211.

According to various embodiments, the optical pattern resin 231 may include various materials such as polyethylene terephthalate (PET) material. According to various embodiments, each of the plurality of optical patterns 232 may include various materials such as polyethylene terephthalate (PET) material.

With this structure, light transmitted through the diffuser plate 210 and the foam layer 220 may be collected while passing through the optical pattern layer 230, and the luminance of the light supplied to the display panel 20 may be improved.

According to one embodiment, the diffuser plate 210 and the foam layer 220 may be coupled to each other.

For example, the diffuser plate 210 may be coupled to the rear surface of the foam layer 220 opposite the display panel 20. The diffuser plate 210 may be attached to and in contact with the rear surface of the foam layer 220.

For example, the foam layer 220 may be coupled to the front surface of the diffuser plate 210 facing the display panel 20. The foam layer 220 may be attached to and in contact with the front surface of the diffuser plate 210.

For example, the diffuser plate 210 and the foam layer 220 may be attached to and in contact with each other through a process in which the diffuser plate resin 211 and the foam layer resin 221 are each cured while in contact with each other.

According to one embodiment, the foam layer 220 and the optical pattern layer 230 may be coupled to each other.

For example, the optical pattern layer 230 may be coupled to the front surface of the foam layer 220 facing the display panel 20. The optical pattern layer 230 may be attached to and in contact with the front surface of the foam layer 220.

For example, each of the plurality of optical patterns 232 may be attached to and in contact with the front surface of the foam layer 220. For example, one surface of each of the plurality of optical patterns 232 adjacent to the foam layer 220 may be attached to and in contact with the front surface of the foam layer 220. For example, in one embodiment in which the plurality of optical patterns 232 includes a plurality of prisms, the plurality of prisms may be attached to and in contact with the front surface of the foam layer 220. For example, the first inclined surface 232a and the second inclined surface 232b of each of the plurality of prisms may extend in an inclined direction with respect to the front and rear direction X from the front surface of the foam layer 220.

For example, the foam layer 220 and the optical pattern layer 230 may be attached in contact with each other through a process in which the foam layer resin 221 and the optical pattern resin 231 (refer to FIGS. 10, 11, 12, and the like) are each cured while in contact with each other.

As mentioned above, the foam layer 220 may be coupled to each of the diffuser plate 210 and the optical pattern layer 230. That is, the foam layer 220 may be coupled to the diffuser plate 210 and the optical pattern layer 230. According to one embodiment, the diffuser plate 210, the foam layer 220, and the optical pattern layer 230 may be coupled to each other to form the integral optical member 200.

Accordingly, according to one embodiment, the optical member 200 may have a simplified structure. In addition, as the diffuser plate 210, the foam layer 220, and the optical pattern layer 230 are coupled to each other, an overall thickness of the optical member 200 may be reduced, and an overall thickness of the display apparatus 1 may be relatively reduced.

In addition, according to one embodiment, because the diffuser plate 210, the foam layer 220, and the optical pattern layer 230 are coupled to each other to form the integral optical member 200, the process of manufacturing the optical member 200 may be further simplified, and the process of assembling the manufactured optical member 200 to components of the display apparatus 1, such as the middle mold 14, may also be further simplified.

In addition, according to one embodiment, as the diffuser plate 210, the foam layer 220, and the optical pattern layer 230 are coupled to each other to form the integral optical member 200, the efficiency in storage and distribution of the optical member 200 may be improved.

A detailed description of the manufacturing method of the optical member 200 will be described later.

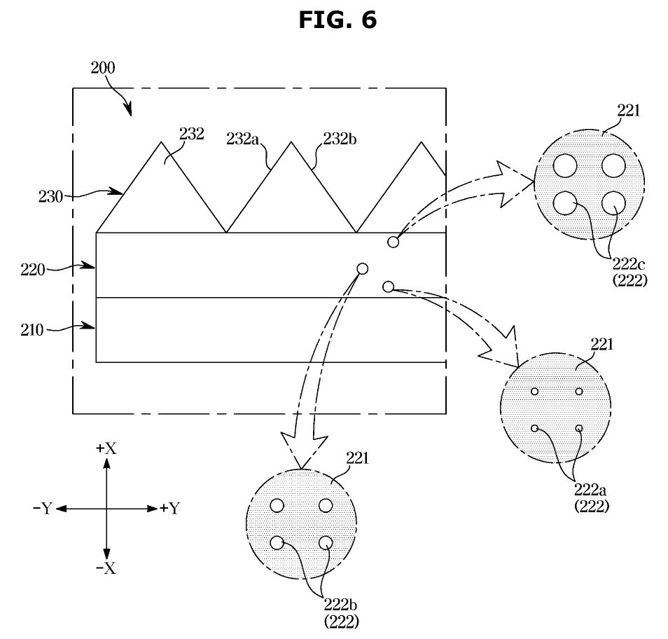

FIG. 6 is an enlarged view of an optical member included in the display apparatus according to one embodiment of the present disclosure.

Referring to FIG. 6, an optical member 200 included in the display apparatus 1 according to one embodiment of the present disclosure may include a foam layer 220 in which distribution of cells 222 varies depending on a distance from a diffuser plate 210 and/or an optical pattern layer 230.

According to one embodiment, a ratio of a volume occupied by the plurality of cells 222 per unit volume within the foam layer 220 may increase as the plurality of cells 222 is closer to the optical pattern layer 230. The ratio of the volume occupied by the plurality of cells 222 per unit volume within the foam layer 220 may decrease as the plurality of cells 222 is closer to the diffuser plate 210. For example, the ratio of the volume occupied by the plurality of cells 222 per unit volume within the foam layer 220 may increase as the plurality of cells 222 is closer to the front (+X direction). More generally, the ratio of the volume occupied by the plurality of cells 222 per unit volume within the foam layer 220 may vary by a location of the plurality of cells 222 with respect to the diffuser plate 210.

According to one embodiment, as illustrated in FIG. 6, a size of each of the plurality of cells 222 included in the foam layer 220 may increase as the plurality of cells 222 is closer to the optical pattern layer 230. The size of each of the plurality of cells 222 may decrease as the plurality of cells 222 is closer to the diffuser plate 210. For example, the size of each of the plurality of cells 222 may increase as the plurality of cells 222 is closer to the front (+X direction).

For example, the plurality of cells 222 may include a plurality of first cells 222a arranged at a first distance from the diffuser plate 210 within the foam layer 220, a plurality of second cells 222b arranged at a second distance greater than the first distance from the diffuser plate 210, and a plurality of third cells 222c arranged at a third distance greater than the second distance from the diffuser plate 210. In this case, a size of the second cell 222b may be greater than a size of the first cell 222a, and a size of the third cell 222c may be greater than the size of the second cell 222b.

As mentioned above, the closer to the optical pattern layer 230 (i.e., the farther from the diffuser plate 210), the greater the size of the plurality of cells 222, and the ratio of the volume occupied by the plurality of cells 222 per unit volume within the foam layer 220 may also increase. More generally, the ratio of the volume occupied by the plurality of cells 222 per unit volume within the foam layer 220 may vary by a location of the plurality of cells 222 with respect to the diffuser plate 210.

According to various embodiments, the number of cells 222 arranged per unit volume within the foam layer 220 may be substantially constant regardless of the distance from the diffuser plate 210 or the optical pattern layer 230, or may increase as the distance from the optical pattern layer 230 decreases (as the distance from the diffuser plate 210 increases).

According to one embodiment of FIG. 6, because the ratio of the volume occupied by the plurality of cells 222 per unit volume within the foam layer 220 increases as the plurality of cells 222 is closer to the optical pattern layer 230, light may be excessively diffused in an area of the foam layer 220 adjacent to the diffuser plate 210. Occurrence of light leakage to an outside of an edge of the optical member 200 (for example, in the horizontal direction Y or a direction close thereto) may be reduced and/or prevented, and a light diffusion rate may be increased in an area adjacent to the optical pattern layer 230. As a result, the luminance of the light supplied to the display panel 20 may be improved and simultaneously, the uniformity of luminance or shielding properties of the light may be improved.

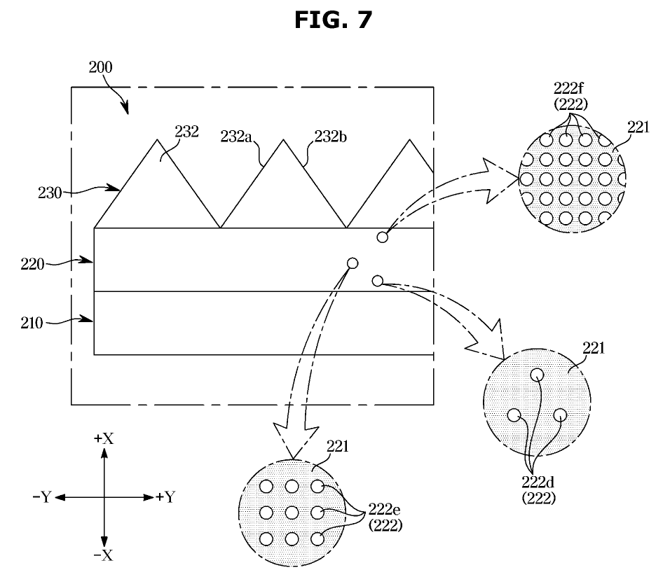

FIG. 7 is an enlarged view of an optical member included in the display apparatus according to one embodiment of the present disclosure.

Referring to FIG. 7, an optical member 200 included in the display apparatus 1 according to one embodiment of the present disclosure may include a foam layer 220 in which distribution of cells 222 varies depending on a distance from a diffuser plate 210 and/or an optical pattern layer 230.

According to one embodiment, a ratio of a volume occupied by the plurality of cells 222 per unit volume within the foam layer 220 may increase as the plurality of cells 222 is closer to the optical pattern layer 230. The ratio of the volume occupied by the plurality of cells 222 per unit volume within the foam layer 220 may decrease as the plurality of cells 222 is closer to the diffuser plate 210. For example, the ratio of the volume occupied by the plurality of cells 222 per unit volume within the foam layer 220 may increase as the plurality of cells 222 is closer to the front (+X direction). More generally, the ratio of the volume occupied by the plurality of cells 222 per unit volume within the foam layer 220 may vary by a location of the plurality of cells 222 with respect to the diffuser plate 210.

According to one embodiment, as illustrated in FIG. 7, a number density of the plurality of cells 222 within the foam layer 220 may increase as the plurality of cells 222 is closer to the optical pattern layer 230. The number density of the plurality of cells 222 may decrease as the plurality of cells 222 is closer to the diffuser plate 210. For example, the number density of the plurality of cells 222 may increase as the plurality of cells 222 is closer to the front (+X direction).

For example, the plurality of cells 222 may include a plurality of first cells 222d arranged at a first distance from the diffuser plate 210 within the foam layer 220, a plurality of second cells 222e arranged at a second distance greater than the first distance from the diffuser plate 210, and a plurality of third cells 222f arranged at a third distance greater than the second distance from the diffuser plate 210. In this case, a number density of the plurality of second cells 222e may be greater than a number density of the plurality of first cells 222d, and a number density of the plurality of third cells 222f may be greater than the number density of the plurality of second cells 222e.

As mentioned above, the closer to the optical pattern layer 230 (the farther from the diffuser plate 210), the greater the number density of the plurality of cells 222, and the ratio of the volume occupied by the plurality of cells 222 per unit volume within the foam layer 220 may also increase.

According to various embodiments, a size of each of the plurality of cells 222 may be substantially constant regardless of the distance from the diffuser plate 210 or the optical pattern layer 230, or may increase as the distance from the optical pattern layer 230 decreases (as the distance from the diffuser plate 210 increases).

According to one embodiment of FIG. 7, because the ratio of the volume occupied by the plurality of cells 222 per unit volume within the foam layer 220 increases as the plurality of cells 222 is closer to the optical pattern layer 230, light may be excessively diffused in an area of the foam layer 220 adjacent to the diffuser plate 210. Occurrence of light leakage to an outside of an edge of the optical member 200 (for example, in the horizontal direction Y or a direction close thereto) may be reduced and/or prevented, and a light diffusion rate may be increased in an area adjacent to the optical pattern layer 230. As a result, the luminance of the light supplied to the display panel 20 may be improved and simultaneously, the uniformity of luminance or shielding properties of the light may be improved.

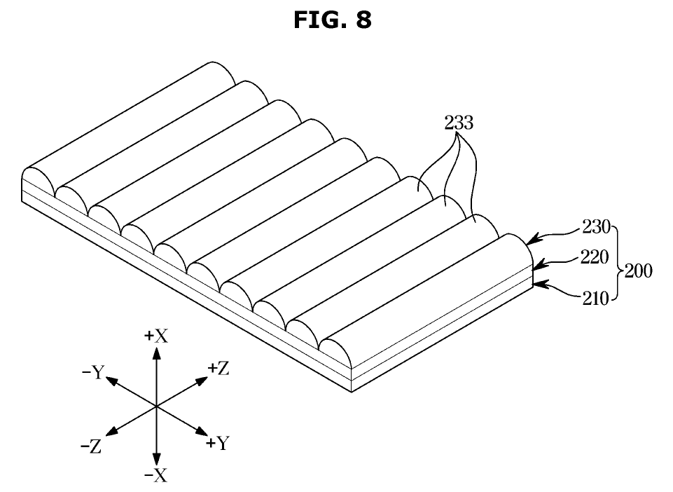

FIG. 8 is a perspective view of an optical member included in a display apparatus according to one embodiment of the present disclosure.

When describing one embodiment of the present disclosure with reference to FIG. 8, the same reference numerals may be given to the same components as those of the embodiments described with reference to FIGS. 1-7, and the corresponding description may not be repeated.

Referring to FIG. 8, an optical member 200 included in a display apparatus 1 according to one embodiment of the present disclosure may include a plurality of optical patterns 233. Each of a plurality of optical patterns 233 may be configured to refract light, which is transmitted through a foam layer 220, toward a display panel 20. Each of the plurality of optical patterns 233 may be configured to collect light transmitted through the foam layer 220. For example, each of the plurality of optical patterns 233 may be configured to refract light, which is transmitted through the foam layer 220, to the front side.

The plurality of optical patterns 233 may be arranged on one surface of the foam layer 220. For example, the plurality of optical patterns 233 may be arranged on a front surface of the foam layer 220 facing the display panel 20.

According to one embodiment, the plurality of optical patterns 233 may be arranged in one direction on one surface of the foam layer 220. For example, the plurality of optical patterns 233 may be arranged in a direction parallel to the long side direction of the screen 12. For example, the plurality of optical patterns 233 may be arranged in the horizontal direction Y. However, an arrangement direction of the plurality of optical patterns 233 is not limited thereto, and the plurality of optical patterns 233 may be arranged in various directions.

Each of the plurality of optical patterns 233 may be coupled to a front surface of the foam layer 220 facing the display panel 20. Each of the plurality of optical patterns 233 may be attached to and in contact with the front surface of the foam layer 220.

According to one embodiment, the plurality of optical patterns 233 may include a plurality of convex lenses having a convex curved shape on a front surface from which light is emitted. Each of the plurality of optical patterns 233 may have a convex lens shape. The plurality of convex lenses may be arranged along one surface of the foam layer 220. For example, the plurality of convex lenses may be arranged along the front surface of the foam layer 220. Each of the plurality of convex lenses may have a width that is reduced from the foam layer 220 toward the display panel 20. For example, each of the plurality of convex lenses may protrude forward from the front surface of the foam layer 220, and as a protrusion length is increased, a width in the horizontal direction may be reduced.

With this structure, light transmitted through the diffuser plate 210 and the foam layer 220 may be collected while passing through the optical pattern layer 230, and the luminance of the light supplied to the display panel 20 may be improved.

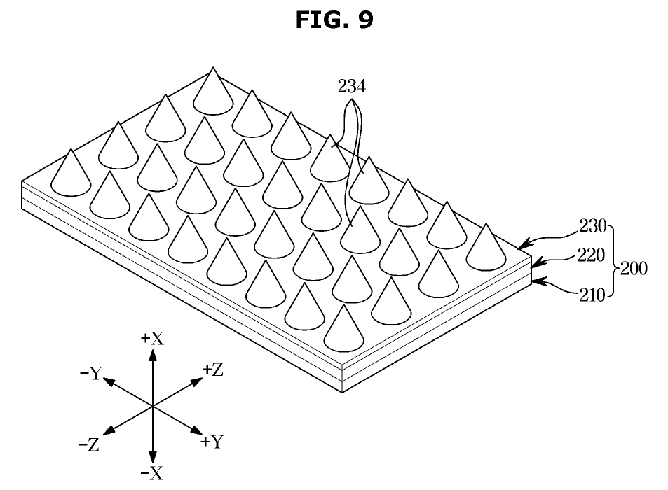

FIG. 9 is a perspective view of an optical member included in a display apparatus according to one embodiment of the present disclosure.

When describing one embodiment of the present disclosure with reference to FIG. 9, the same reference numerals may be given to the same components as those of the embodiments described with reference to FIGS. 1-8, and the corresponding description may not be repeated.

Referring to FIG. 9, an optical member 200 included in a display apparatus 1 according to one embodiment of the present disclosure may include a plurality of optical patterns 234. Each of the plurality of optical patterns 234 may be configured to refract light, which is transmitted through a foam layer 220, toward a display panel 20. Each of the plurality of optical patterns 234 may be configured to collect light transmitted through the foam layer 220. For example, each of the plurality of optical patterns 234 may be configured to refract light, which is transmitted through the foam layer 220, to the front side.

The plurality of optical patterns 234 may be arranged on one surface of the foam layer 220. For example, the plurality of optical patterns 234 may be arranged on a front surface of the foam layer 220 facing a display panel 20.

According to one embodiment, the plurality of optical patterns 234 may be arranged in a matrix form on one surface of the foam layer 220. For example, the plurality of optical patterns 234 may be arranged in a matrix form including a plurality of columns parallel to the horizontal direction Y and a plurality of rows parallel to the vertical direction Z. However, an arrangement direction of the plurality of optical patterns 234 is not limited thereto, and the plurality of optical patterns 234 may be arranged in various directions.

Each of the plurality of optical patterns 234 may be coupled to the front surface of the foam layer 220 facing the display panel 20. Each of the plurality of optical patterns 234 may be attached to and in contact with the front surface of the foam layer 220.

According to one embodiment, the plurality of optical patterns 234 may include a plurality of cone shapes. Each of the plurality of optical patterns 234 may have a cone shape. For example, the cone shape may include a cone shape having a circular cross-section. The plurality of cone shapes may be arranged along one surface of the foam layer 220. For example, the plurality of cone shapes may be arranged along the front surface of the foam layer 220. Each of the plurality of cone shapes may have a width that is reduced from the foam layer 220 toward the display panel 20. For example, each of the plurality of cone shapes may protrude forward from the front surface of the foam layer 220, and as a protrusion length increases, a width in the horizontal direction may be reduced.

With this structure, light transmitted through the diffuser plate 210 and the foam layer 220 may be collected while passing through the optical pattern layer 230, and the luminance of the light supplied to the display panel 20 may be improved.

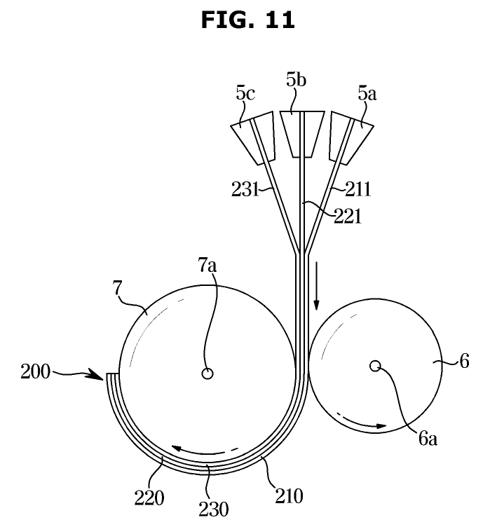

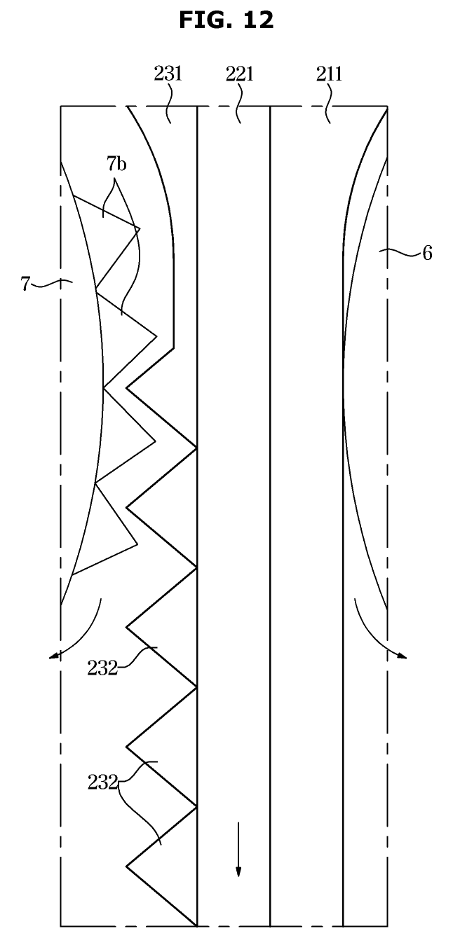

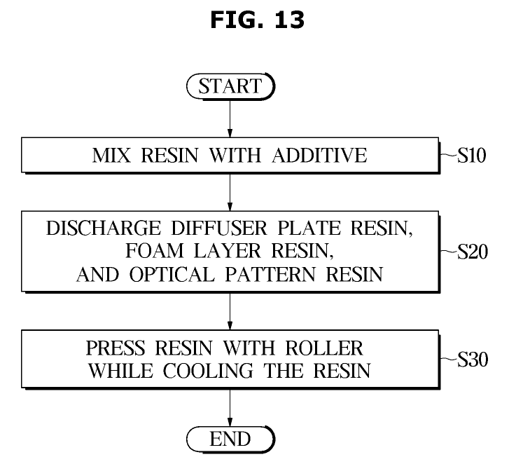

FIG. 10 is a view illustrating an apparatus for manufacturing the optical member included in the display apparatus according to one embodiment of the present disclosure. FIG. 11 is an enlarged view of a portion of the apparatus for manufacturing the optical member included in the display apparatus according to one embodiment of the present disclosure. FIG. 12 is an enlarged view of a roller of the apparatus for manufacturing the optical member included in the display apparatus according to one embodiment of the present disclosure. FIG. 13 is a flowchart illustrating manufacturing operations of the optical member included in the display apparatus according to one embodiment of the present disclosure.

A method for manufacturing the optical member 200 according to one embodiment of the present disclosure is described with reference to FIGS. 10-13.

According to one embodiment, a manufacturing device 2 of the optical member 200 may include a feeder 3. The feeder 3 may be configured to inject a raw material of the optical member 200 into a mixing device 4 to be described later.

For example, the feeder 3 may be configured to inject the diffuser plate resin 211 and the light diffuser 212, which are raw materials for the diffuser plate 210, into the mixing device 4.

For example, the feeder 3 may inject the diffuser plate resin 211, to which the light diffuser 212 is added, into the mixing device 4, or may inject the diffuser plate resin 211 and the light diffuser 212 into the mixing device 4 separately. For example, the feeder 3 may inject the diffuser plate resin 211 in a molten state into the mixing device 4.

For example, the feeder 3 may be configured to inject the foam layer resin 221, which is a raw material for the foam layer 220, and a foaming agent for forming the cells 222, into the mixing device 4. For example, the feeder 3 may inject the foam layer resin 221, to which the foaming agent is added, into the mixing device 4, or may inject the foam layer resin 221 and the foaming agent into the mixing device 4 separately. For example, the feeder 3 may inject the foam layer resin 221 in a molten state into the mixing device 4.

For example, the feeder 3 may be configured to inject the optical pattern resin 231, which is a raw material for the optical pattern layer 230, into the mixing device 4. For example, the feeder 3 may inject the optical pattern resin 231 in a molten state into the mixing device 4.

According to one embodiment, paths, through which the raw materials of the diffuser plate 210 (for example, the diffuser plate resin 211 and the light diffuser 212), the raw materials of the foam layer 220 (for example, the foam layer resin 221 and the cells 222), and the raw materials of the optical pattern layer 230 (for example, the optical pattern resin 231) are injected into the mixing device 4 through the feeder 3, may be partitioned from each other.

According to one embodiment, the manufacturing device 2 of the optical member 200 may include the mixing device 4. The mixing device 4 may be configured to mix raw materials of the optical member 200.

For example, the mixing device 4 may include a diffuser plate resin mixing device 4a. The diffuser plate resin mixing device 4a may be configured to evenly mix the diffuser plate resin 211. The diffuser plate resin mixing device 4a may be configured to evenly mix the diffuser plate resin 211 and the light diffuser 212. For example, the diffuser plate resin mixing device 4a may evenly mix the molten diffuser plate resin 211 and light diffuser 212.

For example, the mixing device 4 may include a foam layer resin mixing device 4b. The foam layer resin mixing device 4b may be configured to evenly mix the foam layer resin 221. The foam layer resin mixing device 4b may be configured to evenly mix the foam layer resin 221 and the foaming agent. For example, the foam layer resin mixing device 4b may evenly mix the molten foam layer resin 221 and the foaming agent.

For example, the mixing device 4 may include an optical pattern resin mixing device 4c. The optical pattern resin mixing device 4c may be configured to evenly mix the optical pattern resin 231. For example, the optical pattern resin mixing device 4c may evenly mix the molten optical pattern resin 231.

According to one embodiment, the mixing device 4 may include a screw device configured to mix the raw materials. For example, each of the diffuser plate resin mixing device 4a, the foam layer resin mixing device 4b, and the optical pattern resin mixing device 4c may include a screw device.

According to one embodiment, the diffuser plate resin mixing device 4a, the foam layer resin mixing device 4b, and the optical pattern resin mixing device 4c may be partitioned from each other. A space in which the diffuser plate resin 211 and the light diffuser 212 are mixed by the diffuser plate resin mixing device 4a, a space in which the foam layer resin 221 and the foaming agent are mixed by the foam layer resin mixing device 4b, and a space in which the optical pattern resin 231 is mixed by the optical pattern resin mixing device 4c may be partitioned from each other.

The raw materials mixed by the mixing device 4 may be transferred to a resin discharger 5.

According to one embodiment, the manufacturing device 2 of the optical member 200 may include the resin discharger 5. The resin discharger 5 may be configured to discharge the diffuser plate resin 211, the foam layer resin 221, and the optical pattern resin 231, respectively. For example, the resin discharger 5 may discharge the diffuser plate resin 211 and the light diffuser 212 that are mixed by the diffuser plate resin mixing device 4a. For example, the resin discharger 5 may discharge the diffuser plate resin 211 in a molten state. For example, the resin discharger 5 may discharge the foam layer resin 221 and the foaming agent that are mixed by the foam layer resin mixing device 4b. For example, the resin discharger 5 may discharge the foam layer resin 221 in a molten state. For example, the resin discharger 5 may discharge the optical pattern resin 231 that is mixed by the optical pattern resin mixing device 4c. For example, the resin discharger 5 may discharge the optical pattern resin 231 in a molten state.

According to one embodiment, the resin discharger 5 may be configured to extrude the diffuser plate resin 211, the foam layer resin 221, and the optical pattern resin 231, respectively. The resin discharger 5 may include an extrusion die configured to extrude the diffuser plate resin 211, the foam layer resin 221, and the optical pattern resin 231, respectively.

For example, the resin discharger 5 may include a diffuser plate resin extrusion die 5a configured to extrude the diffuser plate resin 211 and the light diffuser 212. For example, the diffuser plate resin extrusion die 5a may extrude the diffuser plate resin 211 in a molten state.

For example, the resin discharger 5 may include a foam layer resin extrusion die 5b configured to extrude the foam layer resin 221 and the foaming agent. For example, the foam layer resin extrusion die 5b may extrude the foam layer resin 221 in a molten state. In a process of extruding the foam layer resin 221, the foaming agent added to the foam layer resin 221 may be compressed while passing through the foam layer resin extrusion die 5b, and then the foaming agent may be expanded again and foam.

For example, the resin discharger 5 may include an optical pattern resin extrusion die 5c configured to extrude the optical pattern resin 231. For example, the optical pattern resin extrusion die 5c may extrude the optical pattern resin 231 in a molten state.

In response to the diffuser plate resin 211, the foam layer resin 221, and the optical pattern resin 231 being discharged from the resin discharger 5, the diffuser plate resin 211, the foam layer resin 221, and the optical pattern resin 231 may be discharged so as to be in contact with each other. For example, the diffuser plate resin 211, to which the light diffuser 212 is added, may be discharged to one side of the foam layer resin 221, and the optical pattern resin 231 may be discharged to the other side of the foam layer resin 221. For example, in response to the diffuser plate resin 211, the foam layer resin 221, and the optical pattern resin 231 being discharged from the resin discharger 5, the foam layer resin 221 may be disposed between the diffuser plate resin 211 and the optical pattern resin 231.

After being discharged from the resin discharger 5, each of the diffuser plate resin 211, the foam layer resin 221, and the optical pattern resin 231 may be cured. For example, as the foaming agent foams in the foam layer resin 221, the plurality of cells 222 may be formed, and the foam layer resin 221 may be cured to form the foam layer 220. For example, the diffuser plate resin 211 may be cured on one side of the foam layer resin 221 and formed to be disposed on one surface (for example, the rear surface) of the foam layer 220. For example, the optical pattern resin 231 may be cured on the other side of the foam layer resin 221 and formed to be disposed on the other surface (for example, the front surface) of the foam layer 220.

According to one embodiment, the diffuser plate resin 211, the foam layer resin 221, and the optical pattern resin 231 may be cured by being cooled.

According to one embodiment, the manufacturing device 2 of the optical member 200 may include a first roller 6 and a second roller 7. The first roller 6 and the second roller 7 may press the diffuser plate resin 211, the foam layer resin 221, and the optical pattern resin 231 that are discharged from the resin discharger 5 while the diffuser plate resin 211, the foam layer resin 221, and the optical pattern resin 231 pass between the first roller 6 and the second roller 7. For example, the first roller 6 and the second roller 7 may be rotatable about rotation axes 6a and 7a, respectively, and may be configured to press the diffuser plate resin 211, the foam layer resin 221, and the optical pattern resin 231 while the diffuser plate resin 211, the foam layer resin 221, and the optical pattern resin 231 pass between the first roller 6 and the second roller 7 as the first roller 6 and the second roller 7 rotate. In response to the diffuser plate resin 211, the foam layer resin 221, and the optical pattern resin 231 passing between the first roller 6 and the second roller 7, the diffuser plate resin 211 may come into contact with the first roller 6, and the optical pattern resin 231 may come into contact with the second roller 7.

According to one embodiment, an operation of imprinting the plurality of optical patterns 232 onto the optical pattern resin 231 may be performed in an operation of forming the optical pattern layer 230. According to one embodiment, the second roller 7 may include an imprint portion 7b. The imprint portion 7b may be formed on an outer surface of the second roller 7. The imprint portion 7b may be configured to press the optical pattern resin 231 to imprint the plurality of optical patterns 232 onto the optical pattern resin 231.

According to one embodiment, the diffuser plate resin 211, the foam layer resin 221, and the optical pattern resin 231 may be cured in an operation in which the diffuser plate resin 211, the foam layer resin 221, and the optical pattern resin 231 are pressed by the first roller 6 and the second roller 7. According to one embodiment, the first roller 6 and the second roller 7 may be configured to cool the diffuser plate resin 211, the foam layer resin 221, and the optical pattern resin 231 which are passing between the first roller 6 and the second roller 7. For example, as a low-temperature fluid such as cooling water flows in the first roller 6 and the second roller 7, the first roller 6 and the second roller 7 may be configured to simultaneously press and cool the diffuser plate resin 211, the foam layer resin 221, and the optical pattern resin 231 which are passing between the first roller 6 and the second roller 7.

Through the manufacturing operations, the diffuser plate 210 may be coupled to one surface (for example, the rear surface) of the foam layer 220 and the optical pattern layer 230 may be coupled to the other surface (for example, the front surface) of the foam layer 220 at the operation in which the diffuser plate 210, the foam layer 220 and the optical pattern layer 230 are each formed. Through the manufacturing operations, the diffuser plate 210, the foam layer 220, and the optical pattern layer 230 may be attached to each other to form the integral optical member 200. The manufactured optical member 200 may be wound and stored by a winder 8 of the manufacturing device 2.

According to one embodiment, in the operation of forming the foam layer 220, the plurality of cells 222 may be formed to allow the ratio of the volume occupied by the plurality of cells 222 per unit volume within the foam layer 220 to increase as the plurality of cells 222 is closer to the optical pattern layer 230. For example, in the operation of forming the foam layer 220, the plurality of cells 222 may be formed to allow at least one of the size of each of the plurality of cells 222 or the number density within the foam layer 220 to increase as the plurality of cells 222 is closer to the optical pattern layer 230. In order to ensure that the plurality of cells 222 have such a distribution, in the operation of curing the foam layer 220, the other side of the foam layer resin 221 adjacent to the optical pattern resin 231 may be cooled more slowly than one side of the foam layer resin 221 adjacent to the diffuser plate resin 211. For example, a cooling speed of the resins by the second roller 7 may be less than a cooling speed of the resins by the first roller 6.

A method for manufacturing the optical member 200 according to one embodiment of the present disclosure is described with reference to FIG. 13.

The method for manufacturing the optical member 200 according to one embodiment of the present disclosure may include mixing a resin and an additive (for example, mixing the light diffuser 212 into the diffuser plate resin 211, and mixing the foaming agent into the foam layer resin 221) (S10), and then discharging the diffuser plate resin 211, the foam layer resin 221, and the optical pattern resin 231 (and additives mixed therein), respectively (S20).

For example, the diffuser plate resin 211, the foam layer resin 221, and the optical pattern resin 231 may be extruded by an extrusion die (for example, the diffuser plate resin extrusion die 5a, the foam layer resin extrusion die 5b, and the optical pattern resin extrusion die 5c).

The method for manufacturing the optical member 200 according to one embodiment may include cooling the diffuser plate resin 211, the foam layer resin 221, and the optical pattern resin 231 and pressing the diffuser plate resin 211, the foam layer resin 221, and the optical pattern resin 231 with the first roller 6 and the second roller 7 (S30). In response to the diffuser plate resin 211, the foam layer resin 221, and the optical pattern resin 231 being pressed, the plurality of optical patterns 232 may be imprinted on the optical pattern resin 231 by the imprint portion 7b of the second roller 7. For example, in the operation of cooling the diffuser plate resin 211, the foam layer resin 221, and the optical pattern resin 231, the cooling speed of the side closer to the optical pattern resin 231 may be less than the cooling speed of the side closer to the diffuser plate resin 211. For example, the cooling operation of each of the diffuser plate resin 211, the foam layer resin 221, and the optical pattern resin 231 may be performed by the first roller 6 and the second roller 7.

However, the present disclosure is not limited thereto, and in various embodiments, the cooling operation of each of the diffuser plate resin 211, the foam layer resin 221, and the optical pattern resin 231 may be performed by various processes such as cooling water spraying, cooling air spraying, cooling by a separate cooler different from the first roller 6 and the second roller 7, and the like.

Through the above-mentioned manufacturing method described with reference to FIGS. 10-13, the manufacturing process and assembly process of the optical member 200 may be further simplified and made more efficient. As a result, the manufacturing process or assembly process of the optical member 200 may be more easily automated.

According to one embodiment of the present disclosure, a display apparatus may include a display panel, a light source configured to emit light toward the display panel, and an optical member disposed between the display panel and the light source. The optical member may include a diffuser plate including a plurality of light diffusers and configured to diffuse light emitted from the light source, a foam layer including a plurality of cells and configured to diffuse light transmitted through the diffuser plate, and an optical pattern layer including a plurality of optical patterns and configured to refract light, which is transmitted through the foam layer, toward the display panel. The foam layer may be disposed between the diffuser plate and the optical pattern layer and coupled to each of the diffuser plate and the optical pattern layer.

The optical pattern layer may be attached to and in contact with a front surface of the foam layer facing the display panel.

The plurality of optical patterns may be arranged on the front surface of the foam layer. Each of the plurality of optical patterns may be attached to and in contact with the front surface of the foam layer.

The diffuser plate may be attached to and in contact with a rear surface of the foam layer opposite to the display panel.

A ratio of a volume occupied by the plurality of cells per unit volume within the foam layer may increase as the plurality of cells is closer to the optical pattern layer.

A size of each of the plurality of cells may increase as the plurality of cells is closer to the optical pattern layer.

A number density of the plurality of cells within the foam layer may increase as the plurality of cells is closer to the optical pattern layer.

The plurality of optical patterns may include a plurality of prisms arranged along the front surface of the foam layer facing the display panel. Each of the plurality of prisms may have a width that decreases from the foam layer toward the display panel.

The foam layer may further include a foam layer resin. The diffuser plate may further include a diffuser plate resin. A material of the foam layer resin and a material of the diffuser plate resin may be the same.

According to one embodiment of the present disclosure, a method for manufacturing an optical member for a display apparatus may include: discharging a foam layer resin to which a foaming agent is added; discharging a diffuser plate resin, to which a plurality of light diffusers is added, to one side of the foam layer resin; discharging an optical pattern resin to the other side of the foam layer resin; forming a foam layer by forming a plurality of cells using the foaming agent and curing the foam layer resin; forming a diffuser plate, disposed on one surface of the foam layer and including the plurality of light diffusers, by curing the diffuser plate resin; and forming an optical pattern layer, disposed on the other surface of the foam layer, by imprinting a plurality of optical patterns on the optical pattern resin and curing the optical pattern resin.

The method for manufacturing the optical member for the display apparatus may couple the diffuser plate to the one surface of the foam layer and couple the optical pattern layer to the other surface of the foam layer, when forming the foam layer, the diffuser plate, and the optical pattern layer.

The formation of the foam layer, the diffuser plate, and the optical pattern layer may include pressing the foam layer resin, the diffuser plate resin, and the optical pattern resin using a first roller and a second roller while the foam layer resin, the diffuser plate resin, and the optical pattern resin pass between the first roller and the second roller.

The diffuser plate resin may come into contact with the first roller while passing between the first roller and the second roller. The optical pattern resin may come into contact with the second roller while passing between the first roller and the second roller.

The formation of the optical pattern layer may include imprinting the plurality of optical patterns on the optical pattern resin by pressing the optical pattern resin with an imprint portion formed on an outer surface of the second roller.

The formation of the foam layer, the diffuser plate, and the optical pattern layer may include cooling the foam layer resin, the diffuser plate resin, and the optical pattern resin, which are passing between the first roller and the second roller, by using the first roller and the second roller.

The formation of the foam layer may include forming the plurality of cells to allow at least one of a size of each of the plurality of cells or a number density of the plurality of cells within the foam layer to increase as the plurality of cells is closer to the optical pattern layer.

The curing of the foam layer resin may include cooling the other side of the foam layer resin adjacent to the optical pattern resin more slowly than one side of the foam layer resin adjacent to the diffuser plate resin.

The discharging of the foam layer resin may include extruding the foam layer resin through a foam layer resin extrusion die. The discharging of the diffuser plate resin may include extruding the diffuser plate resin through a diffuser plate resin extrusion die. The discharging of the optical pattern resin may include extruding the optical pattern resin through an optical pattern resin extrusion die.

A refractive index of the optical pattern resin may be greater than a refractive index of the foam layer resin and a refractive index of the diffuser plate resin.

According to one embodiment of the present disclosure, a display apparatus may include: a light source and an optical member configured to transmit and modulate light emitted from the light source. The optical member may include a diffuser plate including a plurality of light diffusers, an optical pattern layer including a plurality of optical patterns, and a foam layer disposed between the diffuser plate and the optical pattern layer and including a plurality of cells. The diffuser plate may be configured to diffuse light emitted from the light source. The foam layer may be configured to diffuse light transmitted through the diffuser plate. The optical pattern layer may be configured to collect light transmitted through the foam layer.

As is apparent from the above description, a diffuser plate, a foam layer, and an optical pattern layer may be coupled to each other so as to form an integral optical member and thus a structure of the optical member may be simplified.

Further, a diffuser plate, a foam layer, and an optical pattern layer may be coupled to each other and thus a thickness of a display apparatus may be reduced.

Further, a diffuser plate, a foam layer, and an optical pattern layer may be coupled to each other so as to form an integral optical member and thus a process for manufacturing the optical member and a process for assembling the optical member into a display apparatus may be simplified.

Further, a manufacturing process or assembly process of an optical member may be simplified so as to be easily automated.

Further, a diffuser plate, a foam layer, and an optical pattern layer may be coupled to each other so as to form an integral optical member and thus efficiency of storage and distribution of the optical member may be improved.

Further, light emitted from a light source may be primarily diffused by a diffuser plate, light transmitted through the diffuser plate may be secondarily diffused by cells in a foam layer, and light transmitted through the foam layer may be collected by an optical pattern layer and provided to a display panel. Accordingly, luminance, uniformity of luminance and shielding properties of a screen may be improved.

Further, as cells of a foam layer are closer to an optical pattern layer, a size or a number density of the cell may increase, and thus luminance, uniformity of luminance and shielding properties of a screen may be improved.

Additional aspects of the disclosure will be set forth in part in the description which follows and, in part, will be obvious from the description, or may be learned by practice of the disclosure.

While the present disclosure has been particularly described with reference to exemplary embodiments, it should be understood by those of skilled in the art that various changes in form and details may be made without departing from the spirit and scope of the present disclosure.

What is claimed:

1. A display apparatus comprising:
a display panel;
a light source configured to emit light toward the display panel; and
an optical member disposed between the display panel and the light source,
wherein the optical member comprises:
a diffuser plate, comprising a plurality of light diffusers, that is configured to diffuse light emitted from the light source;
a foam layer, comprising a plurality of cells, that is configured to diffuse light transmitted through the diffuser plate; and
an optical pattern layer, comprising a plurality of optical patterns, that is configured to refract light, which is transmitted through the foam layer, toward the display panel,
wherein the foam layer is disposed between the diffuser plate and the optical pattern layer and is coupled to each of the diffuser plate and the optical pattern layer.

2. The display apparatus of claim 1, wherein the optical pattern layer is attached to and in contact with a first surface of the foam layer proximal to the display panel.

3. The display apparatus of claim 2, wherein
the plurality of optical patterns are arranged on the first surface of the foam layer,
wherein each of the plurality of optical patterns are attached to and in contact with the first surface of the foam layer.

4. The display apparatus of claim 1, wherein the diffuser plate is attached to and in contact with a second surface of the foam layer distal from the display panel.

5. The display apparatus of claim 1, wherein a ratio of a volume occupied by the plurality of cells per unit volume within the foam layer increases as the plurality of cells is closer to the optical pattern layer.

6. The display apparatus of claim 5, wherein a size of each of the plurality of cells increases as the plurality of cells is closer to the optical pattern layer.

7. The display apparatus of claim 5, wherein a number density of at least one cell of the plurality of cells varies based on a distance of the at least one cell from the optical pattern layer.

8. The display apparatus of claim 1, wherein the plurality of optical patterns comprises a plurality of prisms arranged along a first surface of the foam layer proximal to the display panel,
wherein each of the plurality of prisms has a width that decreases as a distance from the foam layer increases.

9. The display apparatus of claim 1, wherein the foam layer further comprises a foam layer resin; and
the diffuser plate further comprises a diffuser plate resin,
wherein a material of the foam layer resin is the material of the diffuser plate resin.

10. A method for manufacturing an optical member for a display apparatus comprising:
discharging a foam layer resin having a foaming agent added thereto;
discharging a diffuser plate resin having a plurality of light diffusers added thereto;
discharging an optical pattern resin;
forming a foam layer by forming a plurality of cells using the foaming agent and curing the foam layer resin;
forming a diffuser plate on a first surface of the foam layer by curing the diffuser plate resin, the diffuser plate comprising the plurality of light diffusers; and
forming an optical pattern layer on a second surface of the foam layer by imprinting a plurality of optical patterns on the optical pattern resin and curing the optical pattern resin.

11. The method for manufacturing the optical member for the display apparatus of claim 10, wherein when forming the foam layer, the diffuser plate, and the optical pattern layer, the diffuser plate is coupled to the first surface of the foam layer and the optical pattern layer is coupled to the second surface of the foam layer.

12. The method for manufacturing the optical member for the display apparatus of claim 10, wherein the forming of the foam layer, the diffuser plate, and the optical pattern layer further comprises:
pressing the foam layer resin, the diffuser plate resin, and the optical pattern resin using a first roller and a second roller while the foam layer resin, the diffuser plate resin, and the optical pattern resin pass between the first roller and the second roller.

13. The method for manufacturing the optical member for the display apparatus of claim 12, wherein
the diffuser plate resin contacts the first roller while passing between the first roller and the second roller; and
the optical pattern resin contacts with the second roller while passing between the first roller and the second roller.

14. The method for manufacturing the optical member for the display apparatus of claim 13, wherein the forming of the optical pattern layer further comprises:
imprinting the plurality of optical patterns on the optical pattern resin by pressing the optical pattern resin with an imprint portion formed on a surface of the second roller contacting the optical pattern resin.

15. The method for manufacturing the optical member for the display apparatus of claim 12, wherein the forming of the foam layer, the diffuser plate, and the optical pattern layer comprises:
cooling the foam layer resin, the diffuser plate resin, and the optical pattern resin, while the foam layer resin, the diffuser plate resin, and the optical patter resin pass through the first roller and the second roller, by using the first roller and the second roller.

16. The method for manufacturing the optical member for the display apparatus of claim 15, wherein
the first roller has a first cooling speed, and the second roller has a second cooling speed different from the first cooling speed.

17. An optical member for a display apparatus, comprising:
a diffuser plate, comprising a plurality of light diffusers, that is configured to diffuse light emitted from a light source;
a foam layer, comprising a plurality of cells, that is configured to diffuse light transmitted through the diffuser plate; and
an optical pattern layer, comprising a plurality of optical patterns, that is configured to refract light transmitted through the foam layer, and
wherein the foam layer is disposed between the diffuser plate and the optical pattern layer and is coupled to each of the diffuser plate and the optical pattern layer.

18. The optical member of claim 17, wherein a ratio of a volume occupied by at least one cell of the plurality of cells per unit volume within the foam layer varies by location in the foam layer.

19. The optical member of claim 17, wherein a size of at least one cell of the plurality of cells varies based on a distance of the at least one cell from the optical pattern layer.

20. The optical member of claim 17, wherein a number density of at least one cell of the plurality of cells varies based on a distance of the at least one cell from the optical pattern layer.
